(19) United States
(12) Patent Application Publication
(10) Pub. No.: US 2002/0079473 A1
(43) Pub. Date: Jun. 27, 2002

(54) Connectors and valves

(75) Inventor: James Jeory, Preston (GB)

Correspondence Address: Samuels, Gauthier & Stevens, LLP, Suite 3300, 225 Franklin Street, Boston, MA, 02110, US

(73) Assignee: Jeory, Jeory & Ward

(21) Appl. No.: 09/759,979

(22) Filed: Jan. 12, 2001

(30) Foreign Application Priority Data
Dec. 22, 2000 (GB) 0031676.0

(51) Int. Cl. F16L 37/28

(52) U.S. Cl. 251/149.6

(57) ABSTRACT

A combined connector and valve, for example, for connection of an air line to a source of compressed air or to a vacuum source (all for use in an hydraulic fluid line) the connector comprising a one piece housing (112) a spring-loaded valve member (130) located in a bore (118) in the housing. The valve member (130) is removably retained in the bore by means of a threadedly engaged cap (134). A standard spring-loaded sleeve (140) is slidably located on the open end of the housing (112) to provide a means of connection, and a standard ribbed stem (114) may receive a hose at the remote end. The valve cap (134) has surface formations to enable it to be unthreaded from within the connector for retrieval of the valve member (130) for maintenance or replacement.

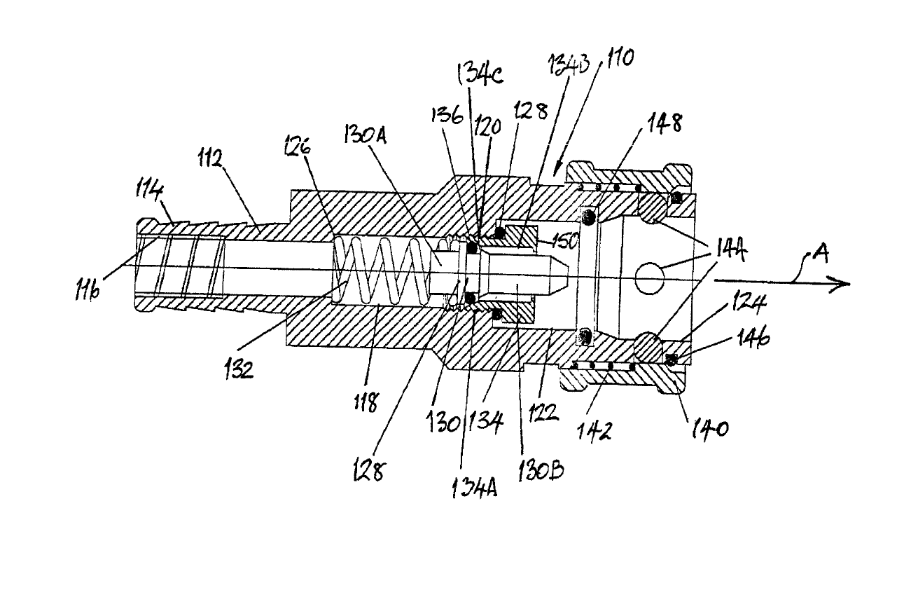

The present invention relates to a combined connector and valve which is particularly useful for connecting an air line to a connector of the type described in our co-pending application number 9900276.8 (GB 2345526).

However, a connector according to the present invention can also be used to connect an air line to a source of compressed air or to a vacuum source, or used in an hydraulic fluid line.

When a connector is to be used in a vacuum line it is particularly important to ensure that the number of leak paths is reduced as far as possible.

Known connectors usually have a body which is formed in two parts in order to allow a spring-loaded valve member to be located in one of the parts of the body and then the two parts of the body are attached together usually by a threaded connection. Even if this screw thread is sealed in some way it remains a potential leak path.

To avoid such a leak path, the present invention seeks to provide a connector having a body of a unitary construction including a hose tail.

The present invention further seeks to provide a connector in which the valve member can be readily removed and replaced.

According to the present invention there is provided, a unitary connector and valve, the connector including a one-piece housing, a spring-loaded valve member located in a bore in the housing, the valve member being removably retained in the housing by means of a cap, the cap having a seat for the valve.

The cap may be threadedly engaged within the housing and removable therefrom to enable removal of the vale member.

The housing may have a first bore in which the valve member is located and a second bore in which the cap is located.

The first bore can have a threaded length, engageable by a threaded length of the cap.

The cap may be formed to receive a removal tool to be inserted in the second bore.

An elongate part of the valve member may extend through a bore in the cap when the valve member is seated.

The present invention will now be more particularly described with reference to the accompanying drawing which shows, in cross section, one form of assembled line connector and valve according to the present invention.

Referring to the drawing, there is shown a unitary connector and valve (110) comprising a housing (112) and a serrated hose tail (114) having a bore (116).

The housing has three main internal bores, the smallest diameter bore being a smooth bore (118) having a threaded length (120) a slightly larger smooth bore (122), and a bore (124) which is the largest in diameter.

A shoulder (126) is formed between the bores (116) and (118) and supports one end of a spring (132).

A valve member (130) having a spindle (130A) is located in the bore (118) and has a shoulder (128) supporting the other end of the spring (132).

The spring (132) is located around spindle (130A) of the valve member (130) and urges the latter in the direction of arrow A in the drawing.

The valve member (130) is retained in position by means of a valve cap (134) which has a screw threaded length (134A) engaging the threaded length (120) of the bore (118). An O-ring (128) forms a seal between the valve cap (134) and the housing (112).

The valve cap (134) has internal bore (134B) which terminates in a conical valve seat (134C), through which a probe (130B) of the valve member (130) protrudes.

The valve member (130) is provided with an O-ring (136) so as to seal the valve member against the valve seat (134C).

The connector has a connecting sleeve (140) of a standard form which houses a spring (142) and ball bearings (144), the sleeve being retained by a ring or cir-clip (146).

The bore (124) also is provided with a seal (148) so as to sealingly engage with any connector inserted into the bore (124).

The valve cap (134) has radially extending slots or other formations on its front face (150) to receive a removal tool whereby the cap (134) may be unthreaded and removed to permit retrieval of the valve member (130).

It will be appreciated that as the housing (112) is a unitary construction a leak path has been removed as compared with the known two component valve housings. Also the unitary design enables the valve member to be introduced through the front of the connector, rather than the rear. To introduce the valve member from the rear would means that the hose tail would have to be a separate component leading to another potential leak path.

The provision of the valve cap (134) allows for easy assembly of the valve member within the housing and replacement and maintenance of the valve member when required.

In the case of known connectors the valve members are usually held in place by cir-clips and it is often extremely difficult or even impossible to remove them when maintenance or replacement is required, resulting in the whole connector having to bc replaced. In the case of the connector according to the present invention the valve member and any other component can bc readily replaced and the connector re-used.

1. A unitary connector and valve, the connector including a one-piece housing, a spring-loaded valve member located in a bore in the housing, the valve member being removably retained in the housing by means of a cap, the cap having a seat for the valve.

2. A connector according to claim 1, wherein the cap is threadedly engaged within the housing and removable therefrom to enable removal of the valve member.

3. A connector according to claim 1, wherein the housing has a first bore in which the valve member is located and a second bore in which the cap is located.

4. A connector according to claim 3, in which the first bore has a threaded length engageable by a threaded length of the cap.

5. A connector according to claim 2, wherein the cap is formed to receive a removal tool to be inserted in the second bore.

6. A connector according to claim 1, wherein the cap has an internal bore and the valve member has an elongate part which extends through the bore in the cap wherein the valve is seated.
